(19) United States
(12) Patent Application Publication
(10) Pub. No.: US 2026/0117950 A1
(43) Pub. Date: Apr. 30, 2026

(54) LIGHTING DEVICE FOR A MOTOR VEHICLE AND MOTOR VEHICLE HAVING SUCH A LIGHTING DEVICE

(71) Applicant: AUDI AG, Ingolstadt (DE)

(72) Inventor: Maximilian MANDERSCHEID, Rohrbach (DE)

(21) Appl. No.: 19/363,304

(22) Filed: Oct. 20, 2025

(30) Foreign Application Priority Data
Oct. 29, 2024 (DE) 102024131568.7

(51) Int. Cl. F21S 41/20; F21S 41/24; F21S 43/20; F21S 43/235

(52) U.S. Cl. CPC F21S 41/2805; F21S 41/24; F21S 43/235; F21S 43/265

(57) ABSTRACT

A lighting device for a motor vehicle is disclosed, and may include at least one light source and a transparent cover through which the light generated by m the at least one light source passes and on which a flat layer having a plurality of discontinuities is provided. Any scattering of the light generated by the at least one light source caused by the layer may be greater than any scattering of the light generated by the at least one light source caused by the cover.

### BACKGROUND

### Technical Field

The present disclosure relates to a lighting device for a motor vehicle, particularly a light device configured to enhance scattering of at least a portion of light produced by the light device.

### Description of the Related Art

Motor vehicle lighting devices designed as exterior lamps serve, on the one hand, to implement illumination of the vehicle’s surroundings to improve visibility for the driver. On the other hand, lighting devices also serve to make the vehicle more visible to other road users. In particular, taillights of the motor vehicle serve to render the vehicle visible to following traffic.

Such lighting devices typically comprise a light source by way of which the light emitted into the surroundings is generated. This light typically exits the lighting device to the outside through an outer cover. To implement a desired light effect, the outer cover often has a coating or layer by way of which a property of the light can be adjusted.

For example, DE102010032190A1 discloses a lighting unit for a motor vehicle, comprising a transparent translucent body forming an outer contour of the lighting unit in a light-emitting region. The translucent body has a decorative coating, such as a colored paint coating. To allow the light to pass through the lighting unit, the coating has perforations with fine openings through which the light passes.

Another concept for a lighting device for a motor vehicle is known from DE3843522A1, comprising a diffusing cover with a metallic coating applied thereto. The coating may be applied only partially to the diffusing cover.

### BRIEF SUMMARY

The present disclosure provides an improved concept in connection with a lighting device of a motor vehicle, especially with regard to providing optimal light-emission properties.

The present disclosure provides a lighting device for a motor vehicle, comprising at least one light source and a transparent cover through which the light generated by way of the at least one light source passes and on which a flat layer having a plurality of discontinuities in which a scattering of the light generated by way of the at least one light source caused by the layer is stronger than a scattering of the light generated by way of the at least one light source caused by the cover.

In the lighting device according to the present disclosure, the light generated by way of the at least one light source thus passes only through the cover in the region of the discontinuities and otherwise through the cover and the layer. In other words, the light that passes through the cover in the region of the discontinuities passes only through the material of the cover, whereas the remaining light passes through both the material of the cover and the material of the layer. In this case, for the portion of the light that passes only through the cover, any scattering that occurs may be less than for the portion of the light that passes through both the cover and the layer. Scattering is understood to mean a diffuse deflection of the light with respect to the direction of propagation.

By way of the lighting device according to the disclosure, a spatial direction-related brightness resulting from the light exiting the lighting device may be increased with respect to certain spatial directions. These are typically spatial directions that may be particularly relevant during the driving operation of the motor vehicle, for example, a straight rearward direction. Although this increase in brightness may occur with a reduction and thus at the expense of brightness with respect to the other spatial directions, this circumstance may be acceptable due to the fact that certain spatial directions are particularly relevant or that particularly high requirements may be placed on the existing brightness for certain spatial directions.

For a better understanding of this advantage, aspects relating to embodiments of the lighting device according to the present disclosure are now set forth, which in this case is designed as a taillight, wherein these configurations may also be implemented independently of one another.

In some embodiments, the light passing through the cover, particularly with respect to light rays that are incident perpendicularly onto the cover, may pass through the cover at least substantially without the occurrence of any scattering. In this case, naturally occurring control effects, such as those due to microscopic irregularities in the surface of the cover, are not taken into account and are negligible.

In some embodiments, the light passing through the layer may be scattered uniformly and maximally. If the cover and thus the layer extend along a planar surface, the light passing through the layer may be scattered uniformly in all directions of the half-space arranged on the exit or observer side of the cover and the layer.

If the cover and the layer extend in a vertical and a transverse direction of the vehicle, i.e., perpendicular to the vehicle longitudinal direction, and the light incident on the cover propagates in the vehicle longitudinal direction, the portion of the light that passes through the cover in the region of the discontinuities may propagate unhindered and straight in a main light-emission direction, which corresponds to the propagation direction of the parallel light before being incident on the cover, and which may extend straight to the rear in the vehicle longitudinal direction. In contrast, the portion of the light that does not pass through the cover in the region of the discontinuities, and thus also passes through the layer, may be scattered uniformly in all spatial directions.

As a consequence, the brightness of the lighting device may appear higher to an observer located in the main light-emission direction compared to the case where the discontinuities are not provided. This effect may also arise in the remaining spatial directions extending at an angle to the main light-emission direction. Thus, the brightness of the lighting device with respect to the main light-emission direction may result both from the portion of the light that passes through the cover in the region of the discontinuities and from the portion of the light that passes through the layer and is scattered in the main light-emission direction. In contrast, the brightness of the lighting device with respect to the remaining spatial directions extending at an angle to the main light-emission direction may result only from the portion of the light that passes through the layer and is scattered in the respective spatial direction. Such a configuration may ensure increased brightness in the main light-emission direction, thus enhancing the visibility of the lighting device, but, at the same time, the lighting device may also be sufficiently visible in the remaining spatial directions due to the light emitted in these directions.

The at least one light source may be at least one light-emitting diode. White and/or colored light may be generated by way of the light source. A brightness of the light generated by way of the at least one light source may be adjustable. To control the light source, such as with regard to color and/or brightness, the light source may be connected to a control device of the lighting device or of the motor vehicle, which may be configured to generate control signals directed thereto and output them to the at least one light source. Such control may be carried out based on control commands defined by the user and/or present during autonomous driving operation of the motor vehicle.

The lighting device according to the present disclosure may comprise an outer cover through which the light generated by way of the at least one light source may exit the lighting device. In this case, the lighting device may have a housing delimiting an interior of the lighting device, with components of the lighting device being arranged in the interior, such as the at least one light source and at least one optical unit explained further below. The outer cover may form a light-emitting region of the lighting device, specifically a section of the housing through which the light exits the housing to the outside. The housing may comprise a metal and/or a plastic, optionally apart from the outer cover. Apart from the outer cover, the housing may be opaque. The cover may comprise an inner surface facing the interior and an outer surface facing the surroundings of the motor vehicle. The layer may be arranged on the inner surface or the outer surface.

In some embodiments, the cover may be the outer cover. In such embodiments, the cover or outer cover may perform multiple functions in a synergistic manner, that is to say, on the one hand, the cover or outer cover may perform the function described above with regard to the desired light-emission properties and, on the other hand, the cover or outer cover may protect the interior against unwanted external influences, such as moisture and/or contamination. In the context of such an embodiment, the number of components may be reduced, thereby reducing weight, cost, and installation space.

Alternatively, the cover may be an intermediate light cover arranged between the at least one light source and the outer cover. Although the advantages explained above may not be present in such a case, such a configuration is also disclosed by way of the present disclosure.

The lighting device according to the present disclosure may comprise at least one carrier plate on which the plurality of light sources are arranged. The carrier plate may also be referred to as a circuit board and, in particular, may form a printed circuit board. The carrier plate may comprise a plastic. The carrier plate may extend along a planar surface. In some embodiments, if the carrier plate is the printed circuit board, the light sources, such as the light-emitting diodes, may be electrically connected or soldered thereto.

In some embodiments, the cover and the carrier plate may be arranged opposite one another in or on the interior of the lighting device, including with respect to the vehicle longitudinal direction and/or the main light-emission direction in some embodiments. In some embodiments, if both the cover and the carrier plate extend along a planar surface, the cover and the carrier plate may be arranged parallel to one another.

In some embodiments, the lighting device according to the disclosure may comprise at least one optical unit, by way of which a path of the light generated by way of the at least one light source within the interior of the lighting device is defined. The optical unit may cause an otherwise rectilinear path of the light to be changed as desired. In this case, the path of the light may be influenced via refraction and/or reflection processes brought about by way of the optical unit. The path may be defined by way of the optical unit in such a way that the light generated by way of the at least one light source reaches the light-emitting region to a large extent or at least substantially in its entirety.

In some embodiments, the at least one optical unit may cause at least part of the light generated by way of the at least one light source to be incident on the cover and/or the layer in an at least substantially parallelized manner. Thus, the propagation direction of the parallelized light may correspond to the main light-emission direction already explained above. In this case, the entire light may be parallelized with respect to a common propagation direction.

In some embodiments, the optical unit or at least one of the optical units may be a lens or a light guide. The lens may be a converging lens. The light guide may be at least one optical fiber, for example made of glass or plastic. The light guide, which may be elongated, may comprise at its front ends an input surface which is arranged in the region of the light source and via which the light is coupled into the light guide, and an output surface which is arranged in the region of the cover or layer and via which the light is coupled out of the light guide.

The optical unit or at least one of the optical units may be arranged between the at least one light source, for example the carrier plate, and the cover. Additionally or alternatively, the optical unit or at least one of the optical units may be configured as a section of the cover, and may be opposite the layer. Thus, the optical unit may form or comprise a curved and/or angled surface of the cover. The layer may be arranged on one of the two surfaces of the cover, and the section of the cover forming the at least one optical unit may be arranged on the surface of the cover opposite the layer.

The discontinuities may be linear. A dimension in a longitudinal direction of the respective discontinuity may therefore be significantly greater than a dimension in a width direction. Thus, with respect to the production of the layer, the layer may be applied to the entire surface of the cover, with the discontinuities, particularly linear discontinuities, being introduced afterward. A tool may be used for this purpose, by way of which the layer is removed in the region of the discontinuities. However, the discontinuities and the layer may also be created simultaneously, for example, by way of rasterized printing.

In some embodiments, the linear discontinuities, or at least a portion thereof, may be arranged parallel to one another and, optionally, at equal distances from each other. The distance between the discontinuities may be a maximum of 1 mm. In some embodiments, a first set and a second set of linear discontinuities, may extend parallel to one another and, optionally, at equal distances from each other. The linear discontinuities of the two sets may extend at an angle to one another, such as perpendicularly. Consequently, the linear discontinuities may form a grid-like pattern.

Additionally or alternatively, the discontinuities may form a pattern. The pattern may be a repeating pattern. The pattern may be formed in such a way that the layer has a plurality of island-like regions, with the gaps between these regions forming the discontinuities. The regions may have dimensions in the sub-millimeter range.

The layer may be a color layer. In some embodiments, if the lighting device is a taillight and/or a brake light, the color layer may be red. In principle, other colors may be utilized, such as white if the lighting device is, for example, a headlight or a reversing light, or yellow if the lighting device is, for example, a direction indicator or turn signal or a warning light of a construction vehicle, or blue if the lighting device is, for example, a warning light of an emergency vehicle, or green if the lighting device is, for example, a warning light of a special vehicle, such as a fire truck. The color layer may be applied wet and then dried. In some embodiments, the color layer may be implemented by way of rasterized color printing.

The layer may be a metal layer. The metal layer may comprise aluminum. The metal layer may be sufficiently thin, for example in the micrometer range, so that, on the one hand, light may pass through the metal layer, for example, under low ambient light conditions such as at night, while, on the other hand, the ambient light may be reflected by the metal layer to create a metallic optical impression, for example, under high ambient light conditions such as, for example, during the day. The metal layer may be vapor-deposited onto the cover.

In some embodiments, the layer may be a roughened surface of the cover. The layer may create a matte finish on the cover. Accordingly, the cover may have a lower roughness in the region of the discontinuities than in the remaining region. In some embodiments, the cover may be smooth in the region of the discontinuities. Microscopically, the roughness may create irregularities on the surface of the cover, which lead to diffuse scattering and reflection effects. The roughened surface of the cover may be produced by sanding and/or sandblasting.

The layer may be a surface structure introduced into the surface of the cover by way of a tool and comprising projections and depressions whose dimensions may be in the sub-millimeter range. Like the roughened surface, the introduced surface structure may produce diffuse scattering and reflection effects. The tool may be an embossing tool. In some embodiments, if the cover comprises a plastic, the surface structure may be formed when the cover is in a temperature range that allows non-destructive deformation of this material.

In some embodiments, the cover comprises transparent glass. In some embodiments, if the layer is provided as the surface structure introduced into the cover, the cover may comprise a transparent plastic, such as, for example, acrylic glass or PMMA.

The present disclosure also relates to a motor vehicle. In a motor vehicle according to the present disclosure, the motor vehicle may comprise at least one lighting device according to the preceding description provided as an exterior lamp. An exterior lamp is understood to mean a lighting device arranged on the outside of the motor vehicle or on a vehicle outer shell. Thus, the light generated by way of the exterior lamp may be emitted into the surroundings of the motor vehicle. The lighting device or at least one of the lighting devices may be a taillight or a headlight of the motor vehicle. All advantages, features, and aspects explained in connection with the lighting device according to the disclosure are equally applicable to the motor vehicle according to the disclosure, and vice versa.

### BRIEF DESCRIPTION OF THE SEVERAL VIEWS OF THE DRAWINGS

FIG. 1 shows a schematic side view of a motor vehicle according to an exemplary embodiment, comprising two lighting devices each according to an exemplary embodiment.

FIG. 2 shows a schematic longitudinal cross-sectional view through a lighting device according to an exemplary embodiment.

FIG. 3 shows a perspective view of a section of a cover and a layer of the lighting device of FIG. 2.

FIG. 4 shows a schematic longitudinal cross-sectional view through a lighting device according to another exemplary embodiment.

FIG. 5 shows a perspective view of a section of a cover and a layer of the lighting device of FIG. 4.

### DETAILED DESCRIPTION

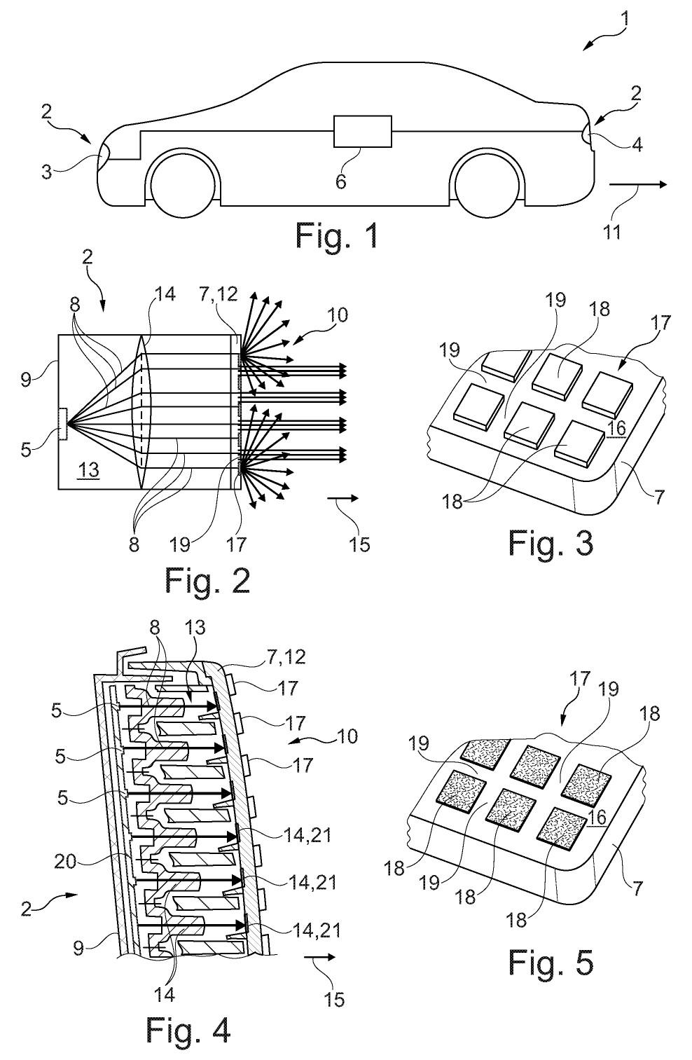

FIG. 1 shows a schematic side view of a motor vehicle 1 according to the present disclosure according to an exemplary embodiment. Motor vehicle 1 comprises a plurality of lighting devices 2 according to the disclosure, provided as exterior lamps, each according to an exemplary embodiment. In this case, two headlights 3 and two taillights 4 are provided as lighting devices 2, although only one headlight 3 and one taillight 4 can be seen in FIG. 1 due to the perspective of this drawing. To control lighting devices 2, that is to say, with regard to the color and brightness of a light 8 generated by way of light sources 5 of respective lighting device 2, each of lighting devices 2 is connected to a control device 6 of motor vehicle 1, which is configured to generate control signals and output them to lighting devices 2, wherein this control can be carried out based on control commands defined by the user or present during autonomous driving operation of motor vehicle 1. By way of headlight 3, lighting can be implemented in a vehicle longitudinal direction 11 to the front and by way of taillight 4, lighting can be implemented in vehicle longitudinal direction 11 to the rear.

FIG. 2 shows a highly schematic longitudinal section through a lighting device 2 according to the disclosure according to a first exemplary embodiment. This lighting device 2 may be taillight 4 of motor vehicle 1 of FIG. 1. In this case, lighting device 2 may comprise a light source 5 and a transparent cover 7 through which light 8 generated by way of light source 5 is emitted to the outside. Light source 5 may be arranged within a housing 9 of lighting device 2 comprising an opaque plastic, wherein cover 7 may form part of housing 9, thus an outer cover 12 of lighting device 2, and a light-emitting region 10. Instead of the configuration shown in FIG. 2, in which cover 7 forms outer cover 12, cover 7 may be a separate component arranged between light source 5 and outer cover 12.

An optical unit 14, which may be a converging lens arranged between light source 5 and cover 7, may be arranged in an interior 13 of lighting device 2, delimited by housing 9 and outer cover 12. A path of light 8 may be defined by way of optical unit 14 in such a way that light 8 is incident on cover 7 in a parallelized manner. The propagation direction of parallelized light 8 may extend in a main light-emission direction 15, which may run parallel to vehicle longitudinal direction 11, i.e., with respect to motor vehicle 1, straight to the rear.

With additional reference to FIG. 3, which shows a perspective representation of a portion of cover 7, the working principle of lighting device 2 with regard to desired light-emission properties is explained below. In this case, a flat layer 17 may be provided on an outer surface 16 of cover 7 facing away from interior 13. However, layer 17 may not be continuously formed without discontinuities, but may be formed of several island-like regions 18, so that layer 17 has discontinuities 19 that separate regions 18 from one another. The size of regions 18 may be in the sub-millimeter range, so that this structure may not be clearly visible at a sufficiently great distance from motor vehicle 1. Layer 17 may equally be arranged on an inner surface of cover 7 facing away from outer surface 16.

With respect to the influence of light 8 by cover 7 and by layer 17, any scattering of light 8 generated by way of light source 5 caused by layer 17 may be stronger than any scattering of light 8 generated by way of the at least one light source 5 caused by cover 7, which may comprise glass or a plastic such as acrylic glass. Specifically, no scattering of light 8 may occur in the region of cover 7, whereas in the region of layer 17 the light may be scattered uniformly with respect to the spatial directions pointing at least partially to the right in FIG. 2. Consequently, the portion of light 8 that passes through cover 7 in the region of discontinuities 19 may not pass through layer 17, but may propagate unhindered in main light-emission direction 15. In contrast, the portion of light 8 that does not pass through cover 7 in the region of discontinuities 19 may reach layer 17, which may diffusely redirect this portion of light 18 in all spatial light-emission directions due to the resulting scattering. Light 8 passing through cover 7 in the region of discontinuities 19 may thus propagates only through the material of cover 7, whereas remaining light 8 may propagate through both the material of cover 7 and the material of layer 17. As a result, the brightness of lighting device 2 with respect to main light-emission direction 15 may be higher than the brightness of lighting device 2 with respect to the remaining spatial directions, which may be at an angle to main light-emission direction 15. Specifically, the maximum brightness and thus the best visibility of lighting device 2 may be present with respect to main light-emission direction 15, with sufficient visibility of lighting device 2 with respect to the remaining spatial directions due to light 8 emitted in these directions.

With respect to the linear design of discontinuities 19, which may form a repeating grid pattern, it should be noted that this configuration is provided merely as an example. Alternatively, curved discontinuities 19 and/or connected regions 18 may also be provided. With respect to layer 17, the layer 17 may be a color layer applied by way of color printing, wherein the color, optionally like light 8 itself, may be, for example, red. Alternatively, layer 17 may be a metal layer which, on the one hand, is sufficiently transparent or translucent with respect to light 8, and, on the other hand, may reflect ambient light originating from the outside. The metal layer may be produced by vapor deposition of a metal, such as aluminum, onto cover 7.

Reference is now made to FIGS. 4 and 5, which essentially correspond to FIGS. 2 and 3, but show a second exemplary embodiment of lighting device 2 according to the present disclosure. In principle, all aspects explained in connection with the first exemplary embodiment of lighting device 2, in particular the aspects relating to the increased brightness in main light-emission direction 15, are transferable to the second exemplary embodiment, unless expressly stated otherwise.

Thus, in the second exemplary embodiment of lighting device 2, a plurality of light sources 5 configured as light-emitting diodes may be provided, which may be arranged on a planar carrier plate 20. Carrier plate 20 may be a circuit board or printed circuit board onto which light sources 5 are soldered. Furthermore, in this exemplary embodiment, a plurality of lenses may be provided as optical units 14 for parallelizing light 8. With respect to optical units 14, the optical units 14 may alternatively also be configured as light guides, such as optical fibers, by way of which the light from light sources 5 is guided to cover 7 and layer 17, thereby parallelizing light 8. A further aspect regarding optical units 14 concerns the fact, as indicated in FIG. 4, that the optical units 14 may also be curved sections 21 of cover 7. These sections 21 may be provided on the surface facing away from layer 17, i.e., the inner surface of cover 7.

A further difference from the first exemplary embodiment concerns the specific configuration of layer 17. Here, in the second exemplary embodiment, layer 17 may be a roughened surface of cover 7, produced, for example, by sanding or sandblasting, as indicated by the dotted area in FIG. 5. Alternatively, layer 17 may be a surface structure introduced into outer surface 16 of cover 7 by way of a tool and comprising projections and depressions, which may have been introduced into outer surface 16, such as by way of an embossing tool.

German patent application no. 102024131568.7, filed October 29, 2024, to which this application claims priority, is hereby incorporated herein by reference, in its entirety.

Aspects of the various embodiments described above can be combined to provide further embodiments. In general, in the following claims, the terms used should not be construed to limit the claims to the specific embodiments disclosed in the specification and the claims, but should be construed to include all possible embodiments along with the full scope of equivalents to which such claims are entitled.

1. A lighting device for a motor vehicle, comprising:
at least one light source configured to generate light; and
a transparent cover through which the light generated by the at least one light source passes and on which a flat layer having a plurality of discontinuities is provided,
wherein any scattering of the light generated by the at least one light source caused by the flat layer is stronger than any scattering of the light generated by the at least one light source caused by the transparent cover.

2. The lighting device according to claim 1, further comprising an outer cover through which the light generated by the at least one light source exits the lighting device, wherein the transparent cover is an intermediate light cover arranged between the at least one light source and the outer cover.

3. The lighting device according to claim 1, wherein the transparent cover is an outer cover through which the light generated by the at least one light source exits the lighting device.

4. The lighting device according to claim 1, further comprising at least one carrier plate on which the at least one light source is arranged.

5. The lighting device according to claim 1, further comprising at least one optical unit configured to define a path of the light generated by the at least one light source within an interior of the lighting device.

6. The lighting device according to claim 5, wherein the at least one optical unit is configured to cause at least part of the light generated by the at least one light source to be incident on the transparent cover and/or the layer in an at least substantially parallelized manner.

7. The lighting device according to claim 5, wherein the at least one optical unit is a lens or a light guide.

8. The lighting device according to claim 7, wherein the at least one optical unit is an optical fiber.

9. The lighting device according to claim 5, wherein the at least one optical unit:
is arranged between the at least one light source, in particular the carrier plate, and the transparent cover; or
is configured as a section of the transparent cover, in particular opposite the layer.

10. The lighting device according to claim 5, wherein the at least one optical unit is arranged between a carrier plate of the at least one light source and the transparent cover, wherein the at least one light source is arranged on the carrier plate.

11. The lighting device of claim according to claim 5, wherein the at least one optical unit is configured as a section of the transparent cover opposite the layer.

12. The lighting device according to claim 1, wherein the discontinuities are linear and/or form a pattern.

13. The lighting device according to claim 1, wherein the layer is a color layer.

14. The lighting device according to claim 1, wherein the layer is a metal layer.

15. The lighting device according to claim 1, wherein the layer is a roughened surface of the transparent cover.

16. The lighting device according to claim 1, wherein the layer is a surface structure comprising projections and depressions.

17. The lighting device according to claim 1, wherein the transparent cover comprises a transparent glass or a transparent plastic.

18. The lighting device according to claim 17, wherein the transparent cover comprises an acrylic glass.

19. A motor vehicle, comprising:
at least one lighting device provided as an exterior lamp, the at least one lighting device including:
at least one light source configured to generate light; and
a transparent cover through which the light generated by the at least one light source passes and on which a flat layer having a plurality of discontinuities is provided,
wherein any scattering of the light generated by the at least one light source caused by the flat layer is stronger than any scattering of the light generated by the at least one light source caused by the transparent cover.

20. The motor vehicle according to claim 19, wherein the at least one lighting device is a headlight or a taillight of the motor vehicle.
